(19) United States
(12) Patent Application Publication
(10) Pub. No.: US 2019/0152486 A1
(43) Pub. Date: May 23, 2019

(54) LOW-LATENCY TEST BED FOR AN IMAGE- PROCESSING SYSTEM

(71) Applicant: dSPACE digital signal processing and control engineering GmbH, Paderborn (DE)

(72) Inventors: Frank Schuette, Warburg (DE); Hagen Haupt, Altenbeken (DE); Carsten Grascher, Paderborn (DE)

(21) Appl. No.: 15/818,787

(22) Filed: Nov. 21, 2017

(51) Int. Cl. B60W 40/04; G06T 1/20; G06F 17/50; G06F 13/40

(52) U.S. Cl. CPC B60W 40/04; G06T 1/20; G06F 17/5009; G06F 13/4068; G05D 1/0231; B60Y 2400/3015; B60Y 2400/3017; B60W 2550/22; B60W 2550/10; G06F 2217/16

(57) ABSTRACT

A test bed for an image-processing system includes: a first computing unit arranged in the test bed, wherein the first computing unit is configured to execute simulation software for an environmental model, the simulation software being configured to calculate a first position x(t) and a first speed vector v(t) and to assign the first position x(t) and the first speed vector v(t) to a first virtual object in the environmental model; a second computing unit arranged in the test bed, wherein the second computing unit is configured to cyclically read in a position of the first virtual object in the environmental model and to compute, based on at least the read-in position, first image data representing a two-dimensional, first graphical projection of the environmental model; and an adapter module arranged in the test bed.

### CROSS-REFERENCE TO RELATED APPLICATIONS

Priority is claimed to German Patent Application No. DE 102016119538.3, filed on Oct. 13, 2016.

### FIELD

The invention relates to test beds for image-processing systems, in particular for image-processing assistance systems or automatic controllers for vehicles. A vehicle is understood to mean any device designed to move under its own power, for example a land vehicle, an aircraft, a boat or a submersible.

### BACKGROUND

Hardware-in-the-loop simulation has been established as part of the development and evaluation chain of safety-critical electronic control units for many years. In this process, a prototype of the control unit is connected to a simulator that uses software to simulate the surroundings of the control unit, and data are generated for data inputs of the control unit, for example by simulating sensors, and are input into the data inputs. Conversely, the simulator reads data from data outputs of the control unit and considers said data when calculating the next time step of the simulation, for example by simulating actuators. A simulator of this kind can also be designed as a test bed and in this case comprises further physical components in addition to the control unit, which components cooperate with the control unit and are similarly embedded in the simulation; in the case of an automotive control unit, this could be for example a steering system, an engine or an image-producing sensor unit. The control unit thus works in a largely virtual environment in which it can be tested in various situations in a safe and reproducible manner.

Because the control unit controls or monitors a physical system, it works in hard real time. Accordingly, the simulator also has to work in hard real time, i.e. the computation of all data required by the control unit has to be concluded, without fail, within a set time interval, for example 1 ms.

More recently, the automotive industry has developed a range of driving assistance systems which generate images of the vehicle environment, for example radar images, LIDAR (Light Detection and Ranging) images or lens-based optical images, via image-producing sensors using various techniques, which systems read in, utilize and interpret images via control units and, based on the images that have been read in, intervene in the driving behavior or, in the case of experimental autonomous vehicles, even control the vehicle independently of a human driver. Radar-based adaptive cruise control, pedestrian detection or road sign detection systems are examples of this.

A test bed for assistance systems of this kind thus has to be designed to compute the images expected by the control unit and make them available to the control unit. The problem in this case is that computing the images is very computer-intensive and thus takes time. Computing a two-dimensional projection, such as perceived by an image-producing sensor, from a three-dimensional environmental model, such as stored in the simulation software, may well take between 50 to 100 ms according to the available prior art. Such a high degree of latency is not compatible with the above-described real-time requirements of a test bed, and undermines the validity of the simulation results.

German utility model DE 20 2015 104 345 U1 describes a test bed for an image-processing control unit, which test bed reduces the latency of image data for the control unit via an adapter module which, bypassing the image-producing sensor unit, inputs the image data directly into the control unit and thus provides a shorter data path for the image data. The latency resulting from computing the image data cannot be compensated for in this way alone, however.

### SUMMARY

In an exemplary embodiment, the present invention provides a test bed for an image-processing system. The test bed includes: a first computing unit arranged in the test bed, wherein the first computing unit is configured to execute simulation software for an environmental model, the simulation software being configured to calculate a first position x(t) and a first speed vector v(t) and to assign the first position x(t) and the first speed vector v(t) to a first virtual object in the environmental model; a second computing unit arranged in the test bed, wherein the second computing unit is configured to cyclically read in a position of the first virtual object in the environmental model and to compute, based on at least the read-in position, first image data representing a two-dimensional, first graphical projection of the environmental model; and an adapter module arranged in the test bed. The adapter module is configured to read in the first image data, to process the first image data by emulating a first image-producing sensor unit of the image-processing system, and to input the processed first image data into the image-processing system. The first computing unit is further configured to read in control data for an actuator unit which have been computed, based on the processed first image data, by the image-processing system, and to assign a new first speed vector to the first virtual object in consideration of the control data. The test bed is configured to measure the length Δt of the time interval that passes from when the second computing unit begins to compute the first image data until the adapter module finishes processing the first image data. The first computing unit is configured to read in the length Δt of the time interval and to estimate a latency L of the first image data on the basis of the length Δt of the time interval. The first computing unit is configured to determine a first extrapolated position x(t+L) of the first virtual object in consideration of the first position x(t), the first speed vector v(t) and the estimated latency L, and wherein the first extrapolated position x(t+L) is an estimation of the first position of the first virtual object at the time t+L. The second computing unit is configured to read in the first extrapolated position x(t+L) and to compute the first image data on the basis of at least the first extrapolated position x(t+L).

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows, in a simplified manner, a test bed known from the prior art for an image-processing system; and

FIG. 2 schematically shows a preferred embodiment of a test bed according to the invention.

### DETAILED DESCRIPTION

Exemplary embodiments of the invention reduce the imprecision caused by the latency which occurs as a result of computing image data for an image-processing system in a test bed.

In an exemplary embodiment, the invention provides a method for compensating, at least in part, for the latency via temporal extrapolation of the environmental model stored on the simulator, based on a measurement of the latency. In an exemplary embodiment, the invention provides a test bed comprising a first computing unit, in particular a processor (CPU), which is programmed with simulation software for an environmental model. The simulation software is configured at least to compute a first position and a first speed vector for a first virtual object in the environmental model, for example a virtual vehicle, preferably cyclically and in hard real time, and to assign said position and vector to the first virtual object. A second computing unit of the test bed, which unit preferably comprises at least a graphics processor (GPU), is configured to compute first image data which represent a two-dimensional, first graphical projection of the environmental model, and in particular reconstruct an image for an image-producing sensor of the first virtual object. For this purpose, the second computing unit is configured to cyclically read in a first position of the first virtual object and to compute the first image data based on this position.

The test bed further comprises an adapter module for integrating the image-processing system in the test bed or simulation. The adapter module is configured to read in the first image data, to emulate a first image-producing sensor unit of the image-processing system, to process the first image data and to input the processed first image data into the image-processing system.

If the image-processing system were to process, for example, the image from an optical, lens-based camera, the adapter module would record and process the first image data, the processed first image data corresponding to the data which the optical sensor of the camera would input into the image-processing system in the situation reconstructed by the simulation software. During the simulation, the adapter module works, so to speak, as a replacement for the image-producing sensor unit of the image-processing system, said module emulating the image-producing sensor unit, wherein the adapter module, instead of the image-producing sensor unit, provides the image-processing system with the expected image data.

Furthermore, the first computing unit is configured to read in control data for an actuator unit which have been computed, based on the processed first image data, by the image-processing system, and to assign a new speed vector to the first virtual object in consideration of the control data. Thus, if for example the image-processing system is a driving assistance system and, on account of a detected hazardous situation, outputs control data in order to trigger an automatic braking maneuver, then the first computing unit is configured to model the braking maneuver via the first virtual object, in this case a virtual vehicle, in the environmental model.

In order to compensate for the latency occurring when computing the first image data, the test bed is configured to determine the length Δt of the time interval that passes from when the second computing unit begins to compute the first image data until the adapter module finishes processing the first image data. The measured length Δt is stored at a memory address, read out by the first computing unit and used to estimate the latency L of the first image data. The estimated latency L is used by the first computing unit, or the simulation software running thereon, and in consideration of the first position x(t) of the first virtual object, the first speed vector v(t) thereof and the estimated latency L, to determine a first extrapolated position x(t+L).

The first extrapolated position x(t+L) is thus an estimate of the future position of the first virtual object at the time t+L, where t is the current time in the system time or in the simulation. (This is equivalent, since the simulation runs in hard real time.) The second computing unit is configured, in order to compute the first image data, not to read in the current first position x(t), but the first extrapolated position x(t+L). The latency of the first image data is thus compensated for, at least in part, by the second computing unit proceeding from the outset from a future state of the simulated environmental model when computing the first image data. When the first image data computed in this way are finally input into the image-processing system, the environmental model on the first computing unit has ideally also reached said future state, and therefore the first image data in the image-processing system are in line with the current state of the environmental model, and the test bed provides realistic data.

In principle, any numerical integration method can be used to determine the first extrapolated position, for example a Runge-Kutta method of order one or higher. The invention does not guarantee complete compensation for the imprecision resulting from the latency of the first image data. Since, for the estimation of the first extrapolated position, preferably the entire estimated latency L is integrated and the length of L in the normal case is significantly greater than a time step in the simulation of the environmental model, it is not expected for the first extrapolated position x(t+L) to correspond to the actual position which is assigned to the virtual object at the time t+L. In addition, it is possible for the estimated latency L to deviate slightly from the actual latency of the first image data because, for example, the computing time for computing the first image data can vary depending on the state of the environmental model. The imprecision resulting from the stated effects is, however, smaller than that which would be caused by latency of the first image data that is not compensated for, and therefore at least improved simulation results can be achieved using the invention.

In particular, the first virtual object can be a virtual vehicle and the image-processing system can be an automatic controller or an assistance system for a vehicle.

The second computing unit is preferably configured to compute the first image data such that the first projection models a field of view of the first image-producing sensor unit. For this purpose, the second computing unit computes the first image data on the assumption that the image-processing system is an image-processing system of the first virtual object and that the first image-producing sensor unit is installed at a well-defined point on the first virtual object. In order to save computing time and thus keep the latency of the first image data as low as possible from the outset, the second computing unit is configured, in order to compute the first image data, to take account only of those virtual objects in the environmental model which, on this assumption, are within the field of view of the first image-producing sensor unit. In one possible embodiment, the image-processing system is, for example, radar-based adaptive cruise control for an automobile, and the first image-producing sensor unit is thus assumed to be part of a radar system that is arranged in the environmental model on the front face of the first virtual object, in this case a virtual automobile. If the radar system is technically only configured to recognize objects within a range of for example 200 m, then only those virtual objects in the environmental model which are located within the range of 200 m and within the vision cone of the radar system ought to be considered when computing the first image data.

In general, the field of view of an image-producing sensor unit is understood to mean all objects which are visible to the image-producing sensor unit at a given time in the form perceived by the image-producing sensor unit, and the second computing unit is preferably configured, in order to compute the first image data, to consider from the outset only the information which can be gleaned from the field of view of the first image-producing sensor unit according to this definition. For the above-mentioned example, this also means, for example, that the first image data for the radar system should not contain any information on the color of the virtual objects that are visible in the first projection, and that said color information, even if it exists in the environmental model, are not considered from the outset when computing the first image data.

In one embodiment, the length Δt of the time interval is measured such that the test bed, in particular the second computing unit, reads out a system time of the test bed when computing of the first image data begins and provides the first image data with a time stamp in which the read-out system time is stored. After the adapter module has processed the first image data, and before the adapter module inputs the first image data into the image-processing system, the adapter module reads out the time stamp, compares the system time stored in the time stamp with a current system time, determines the length Δt of the time interval by subtracting the two system times, and stores the determined length Δt of the time interval at a memory address that can be accessed by the first computing unit. The first computing unit is configured to read out the determined length Δt of the time interval at the memory address.

In another embodiment, the time is measured on the basis of a digital identification which the test bed, in particular the first computing unit or the second computing unit, generates for the first image data. The digital identification is generated before the first image data are computed and is forwarded to the adapter module together with a first system time of the test bed. The first system time is in this case the system time at the time of forwarding the digital identification. After the second computing unit has computed the first image data, said unit provides the second image data with the digital identification and forwards said data to the adapter module together with the digital identification. The adapter module is configured to read out the digital identification from the first image data and to assign the first image data to the first system time on the basis of the digital identification. After the adapter module has finished processing the first image data, it compares the current system time of the test bed with the first system time in order to determine the length Δt of the time interval, and stores the length Δt at a memory address.

A prerequisite for the two types of measurement is that the test bed has sufficiently swift synchronization of the system time between the components of the test bed.

Advantageously, components of the test bed are connected by a real-time-capable data connection that is configured to stream data, i.e. to transfer a continuous stream of large amounts of data in real time. Specifically, a first real-time-capable data connection is set up between the first computing unit and the second computing unit, and a second real-time-capable data connection, preferably a HDMI (High-Definition Multimedia Interface) connection, is set up between the second computing unit and the adapter module, and a third real-time-capable data connection, preferably an Ethernet connection, is set up between the adapter module and the first computing unit.

Particularly preferably, the first data connection is provided by a real-time-capable bus of the test bed. This embodiment is advantageous insofar as it allows an embodiment of the second computing unit as an integral part of the test bed, and thus has a favorable effect on latency because the internal bus of a typical hardware-in-the-loop simulator is optimized for real-time suitability, i.e. low latency and minor jitters.

Advantageously, the second computing unit is configured to also operate a second image-producing sensor unit, optionally in addition to the first image-producing sensor unit. For example, the image-processing system can contain a stereo camera so that the second computing unit computes two optical images, and the adapter module has to accordingly input two optical images into the image-processing system. In a further embodiment, the image-processing system can contain a plurality of control units comprising a plurality of image-producing sensor units. For this reason, in an advantageous embodiment, the second computing unit is configured to compute at least second image data in parallel with computing the first image data or after computing the first image data, which second image data represent a two-dimensional, second graphical projection of the environmental model for a second image-producing sensor unit of the image-processing system. All of the image data is then preferably pooled together and transferred. For this purpose, the second computing unit is configured to generate a data packet containing the first image data, the second image data and, if present, further image data. If the time interval Δt is measured via a time stamp, the data packet is provided with the time stamp. The adapter module is configured to read in the data packet and, in addition to the previously described processing of the first image data, to also process the second image data by emulating the second image-producing sensor unit and to input the processed second image data into the image-processing system.

Preferably, the estimated latency L is not a static value measured as a one-off, but rather the first computing unit is configured to dynamically adjust the value of the estimated latency L in the course of the simulation. This means that the test bed is configured to cyclically determine the length Δt of the time interval and to cyclically read in said length via the first computing unit in order to dynamically adjust the value of L during simulation to the current latency of the first image data.

In a simple embodiment, this occurs such that the first computing unit cyclically equates the estimated latency L to the current value of the length Δt of the time interval, thus establishes that L=Δt. In another embodiment, the first computing unit is configured to store a plurality of previously measured values for Δt and to calculate the latency L from the plurality of values for Δt, in particular as a mean value, a weighted mean value or a median of the plurality of values for Δt.

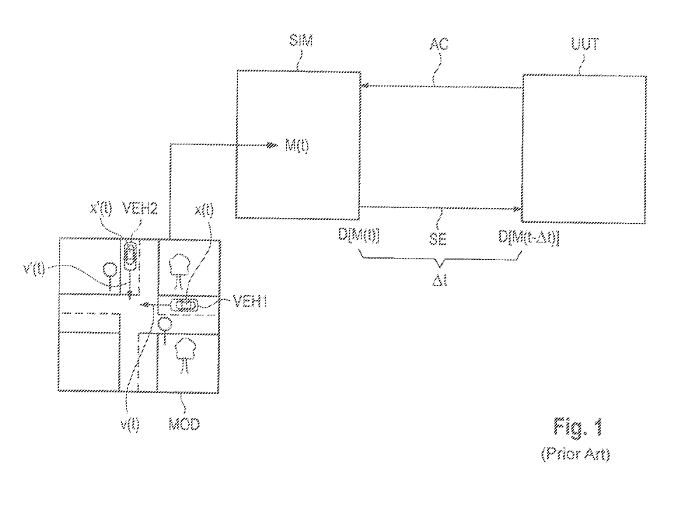

The drawing in FIG. 1 is used to illustrate a test scenario with a test bed, shown representatively by a simulation computer SIM, and an image-processing system UUT as the test subject. The image-processing system UUT is intended to be an example of a camera-based accident assistant which is configured to recognize a hazardous situation in a vehicle and to trigger an automatic braking maneuver.

An environmental model MOD is stored on the simulator SIM. The environmental model MOD is software which can be executed by a first processor of the simulator SIM and is configured to simulate an environment of the image-processing system UUT and a test scenario for the image-processing system UUT. The environmental model MOD contains a plurality of virtual objects, and a subset of the virtual objects are movable. Movable virtual objects are characterized in that in the environmental model, in addition to a (vector-value) position, a speed vector is also assigned to each of said objects, and the position of said objects within the environmental model MOD can be changed at each time step of the simulation. The environmental model MOD shown contains, for example, a first virtual vehicle VEH1 as the first virtual object and a second virtual vehicle VEH2 as the second virtual object. The test scenario shown is an accident situation at an intersection. Both vehicles are movable virtual objects. Therefore, a time-dependent first position x(t) and a time-dependent first speed vector v(t) are assigned to the first virtual vehicle VEH1, and a time-dependent second position x′(t) and a time-dependent second speed vector v′(t) are assigned to the second virtual vehicle VEH2.

The state of the environmental model MOD at a time t can thus be described by a state vector M(t) containing, as entries, the coordinates of the positions of all the virtual objects and the entries of the speed vectors of all the movable virtual objects.

The simulator SIM and the image-processing system UUT together span a simulated control loop. The simulator SIM continuously supplies the image-processing system UUT with emulated image data SE, which the image-processing system UUT interprets as real image data, i.e. image data supplied by a physical image-producing sensor unit. On the basis of this image data, the image-processing system UUT sends control data AC back to the simulator, thereby influencing the state M of the environmental model MOD in that the simulator models, on the first virtual vehicle VEH1, the reaction of a physical vehicle to the control data AC.

A time interval of length Δt passes from when computing of the image data SE begins until the image data SE are input into the image-processing system UUT, which interval results essentially from computing and preparing the image data SE. The length Δt thus corresponds to a latency of the image data. Supposing the latency amounted to Δt=50 ms, this would mean that the example of the accident assistant in the simulation only recognizes, and thus reacts to, the hazardous situation at a delay of 50 ms. Such a value would not be acceptable for the test scenario shown, and the results of the simulation would be of limited use.

The image data SE represent a field of view of a first image-producing sensor unit, which is installed at a point on the first virtual vehicle VEH1, thus representing a two-dimensional graphical projection of the environmental model MOD. The image data SE are to be understood as a function D[M(t)] of the state vector M(t) in this respect. The prepared image data which are finally input into the image-processing system UUT are thus defined by the function D[M(t−Δt)]. By substituting t→t+Δt, it is immediately obvious that the latency can in principle be compensated for by the simulator SIM supplying future image data SE, described by the function D[M(t+Δt)], to the image-processing system UUT. The image data input into the image-processing system are then described by the function D[M(t+Δt−Δt)]=D[M(t)], and are thus in line with the current state M(t) of the environmental model MOD.

In principle, the future state M(t+Δt) of the environmental model MOD is not known. However, if the latency Δt is ascertained, for example by a measurement, then said future state can at least be estimated by extrapolating the current state M(t) over the length Δt, and the precision of the simulation can be improved.

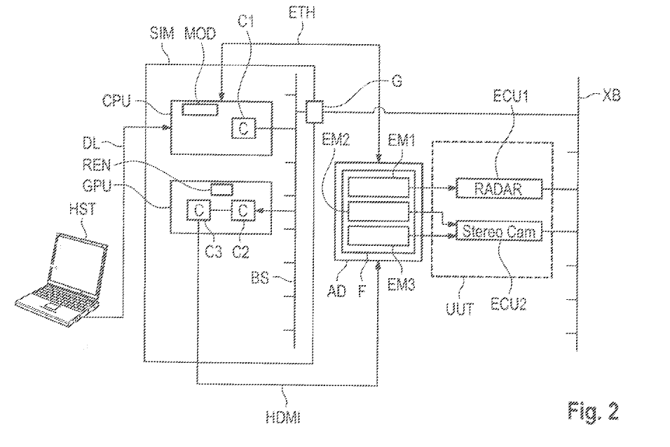

The drawing in FIG. 2 is a schematic view of a test bed configured for this purpose. The test bed comprises a host computer HST, a simulator SIM and an adapter module AD, and the image-processing system UUT comprises a first control unit ECU1 for a radar system and a second control unit ECU2 for a stereo camera.

The simulator SIM comprises a first computing unit CPU having a first processor C1, and the simulator SIM comprises a second computing unit GPU having a second processor C2 and a graphics processor (GPU) C3. The host computer HST is configured to store the environmental model MOD on the first computing unit CPU via a fifth data connection DL, and the first processor C1 is configured to execute the environmental model. (The environmental models MOD shown in FIG. 1 and FIG. 2 are assumed to be identical in the following.) The first computing unit CPU and the second computing unit GPU can together be connected to a first real-time-capable bus BS of the test bed, which bus thus provides a first data connection between the first computing unit CPU and the second computing unit GPU. The first bus BS is technically optimized for real-time suitability and thus ensures a low-latency first data connection.

The first computing unit CPU is configured to cyclically forward positions of the virtual objects in the environmental model to the second computing unit GPU via the first data connection BS. The second computing unit GPU is configured to read out the forwarded positions and to compute, via rendering software REN stored on the second computing unit GPU, first image data, second image data and third image data as functions of at least the forwarded positions, in particular the first position x(t) and the second position x′(t).

For this purpose, the rendering software implements a plurality of shaders. A first shader computes first image data. The first image data represent a first graphical projection of the environmental model MOD, which models the field of view of a radar sensor installed on a first virtual vehicle VEH1. A second shader computes second image data and third image data. The second image data represent a second graphical projection and the third image data represent a third graphical projection of the environmental model. The second and the third graphical projections each form the field of view of a first and a second photosensor of camera optics installed on the virtual vehicle VEH1. For this purpose, the second shader is in particular also configured to simulate the optics of a lens system of the stereo camera.

Simultaneously to the forwarding of the first position x(t) and the second position x′(t), the first computing unit CPU forwards a digital identification and a first system time of the test bed via a third real-time-capable data connection ETH, configured as an Ethernet connection, and also forwards the digital identification to the second computing unit GPU via the first data connection BS. The second computing unit GPU generates a data packet containing the first image data, the second image data, the third image data and the digital identification. The graphics processor C3 forwards the data packet to the adapter module AD via a second real-time-capable data connection HDMI, configured as a HDMI connection.

The adapter module AD comprises an FPGA (field-programmable gate array) F. Three parallel emulation logic systems are implemented on the FPGA F. A first emulation logic system EMI is configured to emulate a first image-producing sensor unit of a radar system, i.e. to record the first image data and process said data such that, after processing, the first image data correspond to the image data expected by the first control unit ECU1. Accordingly, a second emulation logic system EM2 and a third emulation logic system EM3 are configured to record the second image data and the third image data, respectively, and to emulate a second image-producing sensor unit and a third image-producing sensor unit, respectively, of a lens-based optical stereo camera.

The processed first image data are input by the adapter module AD into the first control unit ECU1 such that the first control unit ECU1 interprets said data as real image data from a physical image-producing sensor unit. The technical measures required for this purpose are already known in the prior art and are available to a person skilled in the art. Special development control units often provide dedicated interfaces for this purpose.

The first control unit ECU1 and the second control unit ECU2 compute control signals for an actuator unit of a vehicle, specifically a motor vehicle, based on the processed first image data and the processed second image data, respectively. The control signals are input into the first computing unit CPU via a second bus XB which is outside the simulator SIM, for example a CAN bus, which is connected to the first bus BS via a gateway G, and said signals are read out by the first processor C1 and are taken into consideration when computing the subsequent time step of the simulation, such that the reaction of a physical vehicle to the control signals is reconstructed on the first virtual vehicle VEH1.

The adapter module AD is further configured to assign, on the basis of the digital identification, the data packet to the first system time obtained by the first computing unit. Specifically, this means that the adapter module AD reads out the digital identification forwarded by the first computing unit CPU via the third data connection ETH, together with the first system time, and that the adapter module also reads out the digital identification stored in the data packet, compares the two read-out digital identifications and recognizes them as identical, and assigns the first system time to the data packet on the basis of the comparison. Immediately after processing at least the first image data, the adapter module AD compares the first system time with a current system time of the test bed, determines, by subtraction, the length Δt of the time interval, and forwards the value of Δt to the first computing unit CPU via the third data connection ETH. Preferably, this is not a one-off occurrence, rather the adapter module AD cyclically and continuously computes current values for Δt and continuously forwards the relevant current value of Δt to the first computing unit CPU.

The adapter module requires access to the system time of the test bed in order to be able perform the measurement. Since, in the embodiment shown, the adapter module is not connected to the first bus BS of the test bed, the system time can for example be continuously forwarded to the adapter module AD via the third data connection ETH, and the adapter module AD synchronizes either a local time with the system time or, where necessary, said module directly reads out the system time transferred via the third data connection ETH.

The digital identification can in principle be omitted. In an alternative embodiment, the length Δt is measured using a time stamp, which is provided to the data packet by the second computing unit GPU and in which said unit stores a first system time of the test bed at a time before computing of the first image data begins, the adapter module reading out the first system time from the time stamp.

The first computing unit CPU is configured to read out the value of Δt and to estimate the latency L of the first image data on the basis of the value of Δt. In a simple embodiment, this occurs such that the first computing unit CPU simply uses the relevant current value of Δt for the estimated latency L. This embodiment can be problematic, however, if short-term fluctuations occur in the latency of the image data. Advantageously, the first computing unit CPU computes a value for the estimated latency L on the basis of a plurality of previously measured values of Δt. For example, the first computing unit CPU can be configured to store for example the last 100 values of Δt and to calculate the value of L as a mean value, a weighted mean value or a median of the stored values of Δt.

Compensating for the latency now occurs such that the first computing unit calculates an extrapolated position, using the estimated latency L, for all movable virtual objects in the environmental model, or at least for a selection of relevant movable virtual objects, thus, in the embodiment shown, specifically for the first virtual vehicle VEH1 and for the second virtual vehicle VEH2. The first computing unit CPU thus calculates a first extrapolated position x(t+L) for the first virtual vehicle VEH1 on the basis of the first position x(t) and the first speed vector v(t), and said unit calculates a second extrapolated position x′(t+L) for the second virtual vehicle VEH2 using the second position x′(t) and the second speed vector v′(t). The extrapolated positions are determined for example using a Runge-Kutta method, preferably a Euler method, and preferably using a single integration step over the entire estimated latency L. If the extrapolated positions deviate too significantly from the actual positions at the time t+L, in principle any integration method that is more precise can be used at a price of higher computing time, for example an integration method of a higher order or repeated integration over subintervals of the latency L.

In place of the actual current first positions x(t) and second position x′(t), the first computing unit CPU forwards the first extrapolated position x(t+L) and the second extrapolated position x′(t+L) to the second computing unit GPU. In the same way, rather than the positions of further movable virtual objects that may be present, or at least of those virtual objects that were recognized as relevant for the scenario modeled in the environmental model, it is always the extrapolated position of the relevant virtual object that is transferred. When computing the image data, the second computing unit GPU thus proceeds from the outset from an estimated future state of the environmental model MOD after the timespan Δt has elapsed. When the image data computed in this manner are finally input into the image-processing system UUT, the simulation on the first computing unit CPU has more or less caught up with this time advantage of the image data. The control data from the image-processing system UUT are thus better aligned with the current state M(t) of the environmental model MOD, which improves the precision of the simulation results compared with test beds known from the prior art.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A test bed for an image-processing system), wherein the test bed comprises:
a first computing unit arranged in the test bed, wherein the first computing unit is configured to execute simulation software for an environmental model, the simulation software being configured to calculate a first position x(t) and a first speed vector v(t) and to assign the first position x(t) and the first speed vector v(t) to a first virtual object in the environmental model;
a second computing unit arranged in the test bed, wherein the second computing unit is configured to cyclically read in a position of the first virtual object in the environmental model and to compute, based on at least the read-in position, first image data representing a two-dimensional, first graphical projection of the environmental model; and
an adapter module arranged in the test bed, wherein the adapter module is configured to read in the first image data, to process the first image data by emulating a first image-producing sensor unit of the image-processing system, and to input the processed first image data into the image-processing system;
wherein the first computing unit is further configured to read in control data for an actuator unit which have been computed, based on the processed first image data, by the image-processing system, and to assign a new first speed vector to the first virtual object in consideration of the control data;
wherein the test bed is designed configured to measure the length Δt of the time interval that passes from when the second computing unit begins to compute the first image data until the adapter module finishes processing the first image data;
wherein the first computing unit is configured to read in the length Δt of the time interval and to estimate a latency L of the first image data on the basis of the length Δt of the time interval:
wherein first computing unit is configured to determine a first extrapolated position x(t+L) of the first virtual object in consideration of the first position x(t), the first speed vector v(t) and the estimated latency L, and wherein the first extrapolated position x(t+L) is an estimation of the first position of the first virtual object at the time t+L; and
wherein the second computing unit is configured to read in the first extrapolated position x(t+L) and to compute the first image data on the basis of at least the first extrapolated position x(t+L).

2. The test bed according to claim 1, wherein the test bed is configured to cyclically calculate the first position x(t) and the first speed vector v(t) in hard real time.

3. The test bed according to claim 1, wherein the first virtual object is a virtual vehicle and the image-processing system is an automatic controller or an assistance system for a vehicle.

4. The test bed according to claim 1, wherein the first projection models a field of view of the first image-producing sensor unit.

5. The test bed according to claim 1, wherein the second computing unit is configured to provide the first image data with a time stamp in which a first system time of the test bed is stored when computing of the first image data begins; and
wherein the adapter module is configured to read out the first system time stored in the time stamp and, after processing of the first image data has finished, to compare the first system time with a current system time in order to determine the length Δt of the time interval, and to store the length Δt at a memory address.

6. The test bed according to claim 1, wherein the test bed is configured to, before computing the first image data, generate a digital identification for the first image data, forward the digital identification to the adapter module, and forward to the adapter module a first system time of the test bed at the time of forwarding of the digital identification;
wherein the test bed is configured to provide the first image data with the digital identification; and
wherein the adapter module is configured to assign the first image data to the first system time on the basis of the digital identification and, after processing of the first image data has finished, compare the current system time of the test bed with the first system time in order to determine the length Δt of the time interval, and store the length Δt at a memory address.

7. The test bed according to claim 1, wherein a first real-time-capable data connection is between the first computing unit and the second computing unit;
wherein a second real-time-capable data connection is between the second computing unit and the adapter module; and
wherein a third real-time-capable data connection is between the adapter module and the first computing unit.

8. The test bed according to claim 7, wherein the first data connection is provided by a bus of the test bed.

9. The test bed according to claim 1, wherein the second computing unit is configured to compute at least second image data in parallel with computing the first image data or after computing the first image data, wherein the second image data represent a two-dimensional, second graphical projection of the environmental model for a second image-producing sensor unit of the image-processing system, and to generate a data packet containing at least the first image data and the second image data; and
wherein the adapter module is configured to read in the data packet, to process the second image data by emulating the second image-producing sensor unit of the image-processing system, and to input the processed second image data into the image-processing system.

10. The test bed according to claim 1, wherein the test bed is configured to cyclically determine the length Δt of the time interval, and the first computing unit is configured to cyclically read in the length Δt of the time interval.

11. The test bed according to claim 10, wherein the first computing unit is configured to dynamically adjust the estimated latency L to the time interval Δt by the first computing unit cyclically establishing that L=Δt.

12. The test bed according to claim 10, wherein the first computing unit is configured to dynamically adjust the estimated latency L by the first computing unit calculating a value for the latency L from a plurality of values previously measured for Δt, such that the first computing unit (CPU) calculates the latency L as a mean value, a weighted mean value, or a median of the values previously measured for Δt.

13. The test bed according to claim 1, wherein the second computing unit is configured to optionally compute first image data for at least two different image-producing sensor units.

14. The test bed according to claim 1, wherein the simulation software is configured to calculate a second position x′(t) and a second speed vector v′(t) and to assign the second position x′(t) and the second speed vector v(t) to a second virtual object in the environmental model;
wherein the first computing unit is configured to determine a second extrapolated position x′(t+L) of the second virtual object in consideration of the second position x′(t), the second speed vector v′(t) and the estimated latency L; and
wherein the second computing unit is configured to read in the second extrapolated position x′(t+L) and to compute the first image data on the basis of at least the first extrapolated position x(t+L) and the second extrapolated position x(t+L).

15. A method for testing an image-processing system using a test bed, wherein a first computing unit of the test bed is programmed with simulation software for an environmental model and wherein the method comprises:
cyclically calculating, by the first computing unit via the simulation software, in hard real time a first position x(t) and a first speed vector v(t) and assigning the first position x(t) and the first speed vector v(t) to a first virtual object in the environmental model;
cyclically reading in, by a second computing unit of the test bed, a position of the first virtual object in the environmental model, and computing first image data via the second computing unit based on the read-in first position x(t), wherein the first image data represent a two-dimensional, first graphical projection of the environmental model;
reading in, by an adapter module, the first image data and processing, by emulating a first image-producing sensor unit of the image-processing system, the first image data;
inputting, by the adapter module, the processed image data into the image processing system;
reading in, by the first computing unit, control data for an actuator unit, wherein the control data has been computed by the image-processing system based on the processed first image data, and assigning a new first speed vector to the first virtual object in consideration of the control data;
measuring the length Δt of the time interval that passes from when the second computing unit begins to compute the first image data until the adapter module finishes processing the first image data;
estimating a latency L of the first image data on the basis of the length Δt of the time interval;
determining a first extrapolated position x(t+L) in consideration of the first position x(t), the first speed vector v(t) and the estimated latency L, wherein the first extrapolated position x(t+L) is an estimation of the first position of the virtual object at the time t+L; and
computing, by the second computing unit, the first image data based on the first extrapolated position x(t+L).

16. The test bed according to claim 13, wherein the first image data optionally represent a two dimensional graphical projection of at least two graphical projections from the following list: a radar image, a lidar image, an optical image, an optical image having lens aberrations, an optical image having residual light amplification, an infrared image, an ultrasound image.
